(19) United States
(12) Patent Application Publication
(10) Pub. No.: US 2007/0211581 A1
(43) Pub. Date: Sep. 13, 2007

(54) Optical disc cartridge and recording and reproducing apparatus

(75) Inventors: Takashi Yoshida, Hitachinaka-shi (JP); Toshihiko Shimizu, Hitachinaka-shi (JP); Kazushi Yoshida, Hitachinaka-shi (JP); Taichirou Yamashita, Hitachinaka-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/641,867

(22) Filed: Dec. 20, 2006

(30) Foreign Application Priority Data
Dec. 21, 2005 (JP) 2005-367830

(51) Int. Cl. G11B 7/085; G11B 21/08

(52) U.S. Cl. 369/30.85; 369/30.78

(57) ABSTRACT

An object of the invention is to provide a cartridge storing a plurality of sheet-shaped optical discs in a laminated manner in a state of being accommodated in trays, and a recording and reproducing apparatus of the optical disc. A cartridge stores a lot of trays in a laminated manner. The tray is formed by adhering a flat plate and a flat plate respectively having a smaller hole and a larger hole than a sheet-shaped optical disc, adhering a cover which can be opened and closed to the flat plate, and putting the optical disc in the large hole so as to be covered by the cover. The cartridge is moved up and down by a moving table, and the tray is taken out by being hooked by a hook mechanism. At this time, the cover is peeled out by a peeling claw. The optical disc is fixed to a spindle motor to which a glass disc is attached. The optical disc is rotated while being sucked to the glass disc by a fluid force, and is recorded and reproduced by a recording and reproducing portion. The recording and reproducing apparatus is structured such that the optical disc is turned back to the tray and is compressed to the cartridge by the hook mechanism while being covered by the cover.

### BACKGROUND OF THE INVENTION

1. Field of the Invention

The present invention relates to a cartridge storing a plurality of sheet-shaped optical discs and a recording and reproducing apparatus taking out an optical disc from the cartridge so as to record or reproduce data, and storing the optical discs in the cartridge.

2. Description of Related Art

As a structure which stores a lot of optical discs so as to achieve a high capacity, there has been known a disc changer for CD, DVD or the like. Further, as a cartridge storing the sheet-shaped optical discs having a flexibility and a recording and reproducing apparatus thereof, there is patent document 1 (JP-A-2004-134019).

The cartridge described in this publication is structured such that an optical disc is laminated in the cartridge, a sheet is sandwiched and laminated between the optical discs, and the optical discs are put in a small cartridge so as to be laminated. Further, there is disclosed a recording and reproducing apparatus which takes out all the laminated optical discs from the cartridge, thereafter separates in sequence from an outer side by a roller, feeds by the roller, and chucks to a rotating shaft so as to record and reproduce.

The cartridge described in the patent document 1 is hard to take out the optical disc one by one from the cartridge. Further, it is hard to accurately return the optical disc to the cartridge. Further, there is a problem that it is impossible to access in random order. Further, since the recording and reproducing apparatus employs a roller conveyance accompanying a friction and a slip, there is a problem in a damage of the optical disc, a positioning precision at a time of carrying, and a downsizing.

### BRIEF SUMMARY OF THE INVENTION

The present invention is made for solving the problem mentioned above, and an object of the present invention is to provide a high-capacity cartridge which can take out optical discs one by one and can access in a random order, and a recording and reproducing apparatus which can execute a conveyance without damaging the optical disc, a high-speed conveyance, a high-precision positioning and a downsizing.

In order to achieve the object mentioned above, in accordance with a first aspect, there is employed a cartridge which is formed by adhering a flat plate 1 having smaller hole S than the optical disc, and a flat plate 2 having a larger hole L than the optical disc in such a manner that the hole S and the hole L are concentrically arranged, and stores a lot of trays accommodating the optical discs in the hole L of the flat plate 2. Accordingly, it is possible to manufacture the tray which can be processed thin with no warp. Further, since the optical disc is fed while being mounted on the hole L of the flat plate 2, the optical disc is not damaged.

In accordance with a second aspect, there is employed a cartridge which is formed by adhering a flat plate 1 having a smaller hole S than the optical disc, and a flat plate 2 having a larger hole L than the optical disc in such a manner that the hole S and the hole L are concentrically arranged, and adhering an end portion of a sheet-shaped cover to an end portion of the flat plate 2, and stores a lot of trays accommodating the optical discs in the hole L of the flat plate 2. Since the cover is provided, a surface of the optical disc is neither scuffed nor damaged during a conveyance. Further, since it is possible to feed the optical disc while pressing the optical disc by the cover, it is possible to feed the optical disc without dropping the optical disc from the tray even if the optical disc has a warp.

In accordance with a third aspect, there is employed a cartridge which is formed by adhering an end portion of a sheet-shaped cover to an end portion of a flat plate having a smaller hole than the optical disc, and stores a lot of trays accommodating the optical discs between the flat plate and the cover. Since the cover is provided, a surface of the optical disc is neither scuffed nor damaged during a conveyance. Further, since it is possible to feed the optical disc while pressing the optical disc by the cover, it is possible to feed the optical disc without dropping the optical disc from the tray even if the optical disc has a warp. Further, it is possible to make the tray thin.

In accordance with a fourth aspect, there is employed a cartridge which stores a lot of trays in which an end portion of the flat plate is folded back so as to form the cover. It is possible to reduce a cost.

In accordance with a fifth aspect, there is employed a cartridge which stores a lot of trays in which a step is provided by making one side of the flat plate 2 shorter than the flat plate 1, and one side of the cover is protruded to the step portion so as to hold up the cover in the step portion. Accordingly, it is possible to easily hold up the cover.

In accordance with a sixth aspect, there is employed a cartridge which stores a lot of trays in which one side of the cover is protruded from the flat plate so as to hold up the cover in the protruding portion. Accordingly, it is possible to easily hold up the cover.

In accordance with a seventh aspect, there is employed a cartridge which stores a lot of trays in which a hole H passing through the flat plate is provided, and the cover is held up by inserting a member to the hold H. Accordingly, it is possible to easily hold up the cover.

In accordance with an eighth aspect, there is employed a cartridge in which shelves are provided in the cartridge and the trays are stored while being divided per plural numbers. Accordingly, it is possible to reduce a load applied to the tray.

In accordance with a ninth aspect, there is employed a cartridge which stores a lot of sheet-shaped separators by inserting the sheet-shaped separators between the trays. Accordingly, it is possible to prevent the trays from being brought out together at a time of taking out the tray owing to the separator having a low friction coefficient.

In accordance with a tenth aspect, there is employed a cartridge in which one side of the separator is made longer than the tray, and the separator is stopped by a stop plate provided in the cartridge so as to prevent the tray from moving in the taking-out direction. Accordingly, it is possible to prevent the trays from being brought out together at a time of taking out the tray.

In accordance with an eleventh aspect, there is employed a cartridge which stores a lot of trays accommodating the optical discs, and a lot of bag-shaped tray cases accommodating the trays. Accordingly, it is possible to prevent the trays from being brought out together at a time of taking out the trays owing to the tray case having a low friction coefficient.

In accordance with a twelfth aspect, there is employed a cartridge in which the tray case is stopped by a stop plate provided in the cartridge so as to prevent the tray case from moving in the taking-out direction of the tray. Accordingly, it is possible to prevent the trays from being brought out together at a time of taking out the tray.

In accordance with a thirteenth aspect, there is employed a cartridge in which grooves are provided in a side plate of the cartridge at a wider interval than a thickness of the tray, and a lot of the trays are stored by being inserted to the grooves. Accordingly, it is possible to prevent the trays from being brought out together at a time of taking out the tray.

In accordance with a fourteenth aspect, there is employed a recording and reproducing apparatus having trays accommodating the optical discs, and structured such as to hold up an end portion in a take-out side of an adjacent upper tray and hold down an end portion in a take-out side of an adjacent lower tray at a time of taking out the tray from a cartridge storing a lot of the trays. Accordingly, it is possible to prevent the trays from being brought out together at a time of taking out the tray.

In accordance with a fifteenth aspect, there is employed a cartridge which is formed by adhering a flat plate 1 having a smaller hole S than the optical disc, and a flat plate 2 having a larger hole L than the optical disc in such a manner that the hole S and the hole L are concentrically arranged, and, and stores a lot of trays accommodating the optical discs in the hole L of the flat plate 2, and a recording and reproducing apparatus which moves the cartridge upward and downward on a moving table so as to position a target tray to a predetermined position, takes out the target tray by hooking by a hook mechanism, fixes the optical disc to a rotating portion attached to a glass disc, records and reproduces the optical disc by sucking the optical disc to the glass disc on the basis of a fluid force so as to rotate, and stores the optical disc by returning the optical disc back to the tray and compressing the optical disc to the cartridge by the hook mechanism. Accordingly, it is possible to achieve a high-speed conveyance and a highly reliable recording and reproducing.

In accordance with a sixteenth aspect, there is employed a recording and reproducing apparatus in which a cover covering the optical disc is provided in the tray accommodating the optical disc, the cartridge storing a lot of the trays is moved upward and downward by a moving table so as to position a target tray at a predetermined position, the target tray is hooked by a hook mechanism so as to be taken out, the cover is peeled off by a peeling claw, the optical disc is fixed to a rotating portion to which a glass disc is attached, the optical disc is sucked to the glass disc by a fluid force so as to be rotated and recorded and reproduced by a recording and reproducing portion, and the optical disc is turned back to the tray so as to be covered by the cover and be thereafter stored in the cartridge by being compressed to the cartridge by the hook mechanism, at a time of storing. Accordingly, it is possible to achieve a high-speed conveyance, and a highly reliable recording and reproducing.

### EFFECT OF THE INVENTION

In accordance with the present invention, it is possible to provide the high-capacity cartridge which can take out the optical discs one by one so as to access in a random order, and the recording and reproducing apparatus which can achieve the high-speed conveyance, the high-precision positioning and the downsizing without damaging the optical disc.

### BRIEF DESCRIPTION OF THE SEVERAL VIEWS OF THE DRAWINGS

FIG. 1 shows an embodiment of a tray storing an optical disc in accordance with the present invention;

FIG. 2 shows a state in which a cover in FIG. 1 is opened;

FIG. 3 shows a cross sectional view obtained by cutting the tray in FIG. 1 transversely;

FIG. 4 shows an embodiment of a cartridge in which the trays in accordance with the present invention are laminated;

FIG. 5 shows an embodiment of an optical disc recording and reproducing apparatus in accordance with the present invention;

FIG. 6 shows the other embodiment of the tray storing the optical discs in accordance with the present invention;

FIG. 7 shows a view of the tray in FIG. 6 as seen from a side view;

FIG. 8 shows the other embodiment of the tray storing the optical discs in accordance with the present invention;

FIG. 9 shows a state in which a cover of the tray in FIG. 8 is opened;

FIG. 10 shows the other embodiment of the tray storing the optical discs in accordance with the present invention;

FIG. 11 shows the other embodiment of the tray storing the optical discs in accordance with the present invention;

FIG. 12 shows the other embodiment of the tray storing the optical discs in accordance with the present invention;

FIG. 13 shows the other embodiment of the tray storing the optical discs in accordance with the present invention;

FIG. 14 shows the other embodiment of the cartridge in which the trays in accordance with the present invention are laminated;

FIG. 15 shows an embodiment of a mechanism of taking out the tray in accordance with the present invention;

FIG. 16 shows an embodiment in which the tray in accordance with the present invention is stored in a tray case;

FIG. 17 shows the other embodiment of the cartridge in which the trays in accordance with the present invention are laminated; and

FIG. 18 shows the other embodiment of the cartridge storing the trays in accordance with the present invention.

### DETAILED DESCRIPTION OF THE INVENTION

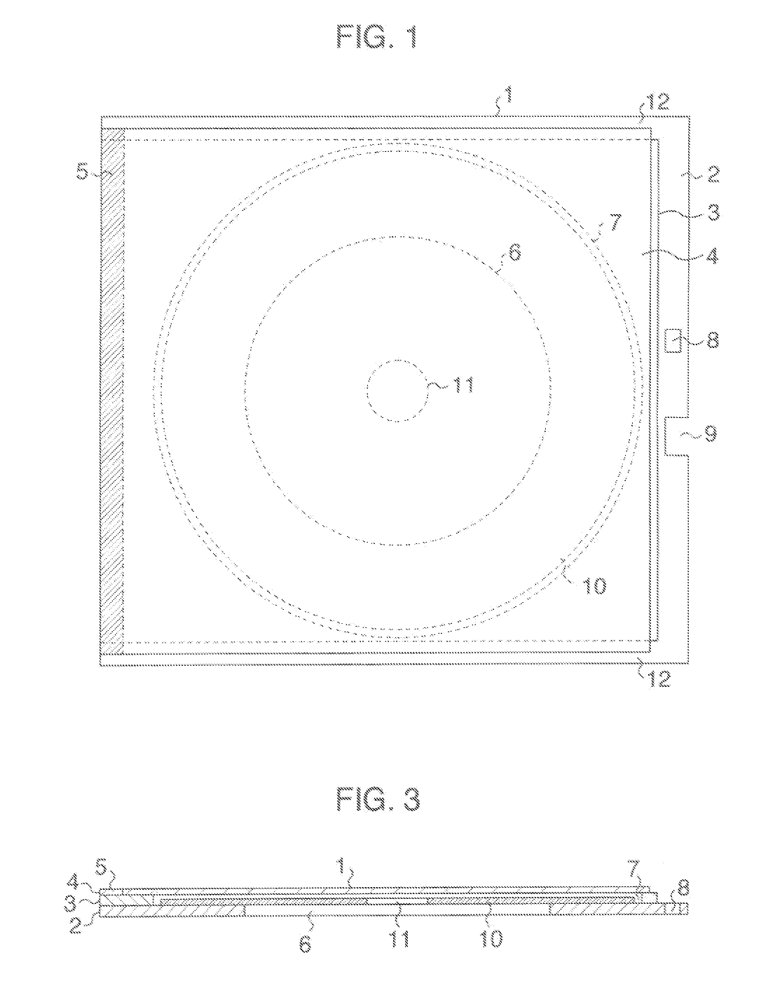

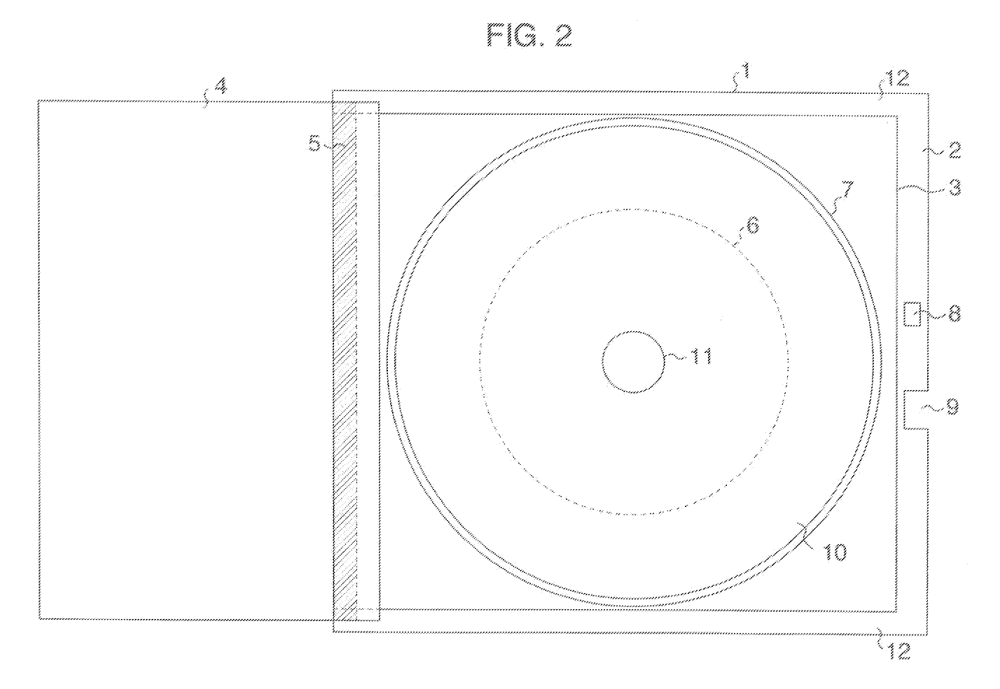

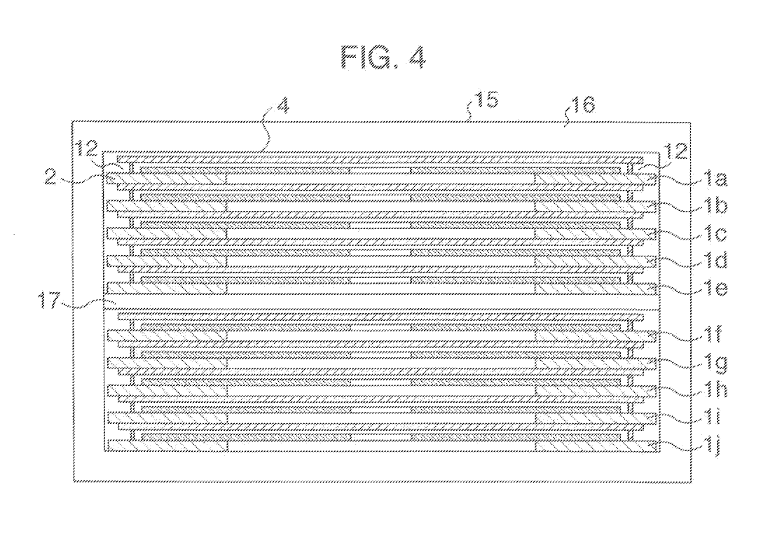

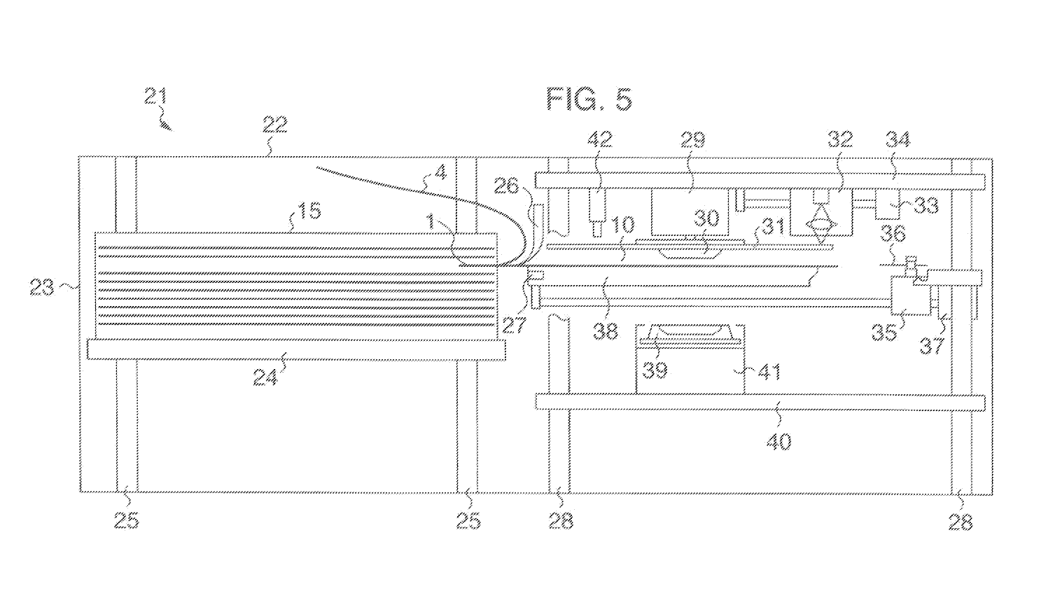

A description will be given of an embodiment of a cartridge storing a plurality of sheet-shaped optical discs in accordance with the present invention, and an optical disc recording and reproducing apparatus for picking up the optical disc from the cartridge so as to record or reproduce data, or storing the optical disc in the cartridge, with reference to FIGS. 1 to 5. FIG. 1 shows a tray 1 storing an optical disc 10. FIG. 2 shows a state in which a cover 4 of the tray 1 in FIG. 1 is opened. FIG. 3 shows a cross sectional view obtained by cutting the tray 1 in FIG. 1 transversely. FIG. 4 shows a cartridge 15 storing a lot of trays 1 in FIG. 1 in a laminated manner. FIG. 5 shows an optical disc recording and reproducing apparatus 21 for picking up the tray 1 accommodating the optical disc 10 from the cartridge 15 so as to record or reproduce data on the optical disc 10, and storing the tray 1 storing the optical disc 10 in the cartridge 15.

A description will be given of a structure of the embodiment of the tray 1 shown in FIGS. 1, 2 and 3. The tray 1 is constituted by a flat plate 2, a flat plate 3 and a sheet-shaped cover 4. The flat plate 3 is adhered to the flat plate 2. The cover 4 is adhered to the flat plate 3 by an adhesive portion 5 shown by a diagonal line. Further, the flat plate 2 is provided with a through hole 6 which is smaller than a diameter of the optical disc 10, a hook hole 8 and a notch portion 9. The flat plate 3 is provided with a through hole 7 which is larger than the diameter of the optical disc 10. The through hole 6 of the flat plate 2 and the through hole 7 of the flat plate 3 are approximately concentrically arranged. The optical disc 10 is stored in a concave portion formed by the flat plate 2 and the through hole 7 of the flat plate 3 so as to be covered by the cover 4. Further, the optical disc 10 has a clamp hole 11 for fixing the optical disc 10 to a spindle motor 29 in FIG. 5. A magnitude of the flat plate 3 is smaller than the flat plate 2 in a width direction so as to form a step portion 12, and is set to a length which does not cover the hook hole 8 and the notch portion 9 in a length direction. Further, a magnitude of the cover 4 is longer than the flat plate 3 in a width direction so as to protrude to the step portion 12, and is approximately equal to the flat plate in a length direction. Further, the through hole 6 of the flat plate 2 is a hole for making a cap 39 for fixing the optical disc 10 to a spindle motor 29 in FIG. 5 pass therethrough. The hook hole 8 of the flat plate 2 is a hole for pulling the tray 1 out of the cartridge 15 by hooking a hook mechanism 36 shown in FIG. 5. Further, the notch portion 9 of the flat plate 2 is provided for widening a gap between the adjacent trays 1 of a lot of trays 1 laminated in the cartridge 15, and the hook hole 8 and the notch portion 9 are alternately formed in odd number places and even number places. One example of the optical disc 10 in accordance with the present invention is structured such that a recording layer is provided on a surface of a base material of a polycarbonate resin, a polyester resin or the like having a thickness of 0.05 mm to 0.2 mm. Further, a hole for clamping having a diameter of 15 mm is provided in a center of a disc having a diameter of 120 mm. One example of the flat plate 2, the flat plate 3 and the cover 4 preferably employs a resin such as a polyethylene terephthalate, an ABS resin or the like and a metal such as a SUS or the like. Thicknesses of the flat plate 2 and the flat plate 3 are between 0.1 and 0.3 mm, and a thickness of the cover 4 is between 0.03 mm and 0.1 mm. A depth of a concave portion in which the optical disc 10 is accommodated is between 0.1 mm and 0.3 mm. Further, the tray 1 can be integrally formed by a mold, or the other elements than the cover 4 may be integrally formed by a mold. In this case, a length of the cover 4 covers a whole of the optical disc 10, however, may cover a part of the optical disc 10.

As mentioned above, in accordance with the present invention, since the tray 1 is structured such that the concave portion mounting the optical disc 10 thereon is formed by adhering the flat plate 2 having the hole having the smaller diameter than the optical disc 10, and the flat plate having the hole having the larger diameter than the optical disc 10 in such a manner that the holes are approximately concentric, it is possible to obtain an effect that the tray having no warp can be manufactured so as to be thin. Further, since the optical disc is fed while being mounted to the concave portion of the tray 1, it is possible to obtain an effect that the optical disc is not damaged.

Further, since the cover 4 is provided in the tray 1, the surface of the optical disc is not scuffed during the conveyance and it is possible to obtain an effect that the optical disc is not damaged. Further, since the optical disc can be fed while being pressed by the cover, there can be obtained an effect that it is possible to feed the optical disc without dropping down from the tray even if the optical disc has such a warp as to jumping out of the concave portion. Further, since the step portion 12 is provided between the cover 4 and the flat plate 2, there can be obtained an effect that it is possible to easily insert a peeling mechanism (a peeling claw 26 in FIG. 5) for holding up the cover 4.

A description will be given of a structure of an embodiment of the cartridge 15 shown in FIG. 4. FIG. 4 shows the tray 1 as seen from a direction of pulling out the tray 1 from the cartridge 15 by a cross sectional view. Further, it shows the step 12 provided between the cover 4 and the flat plate 2. The cartridge 15 is constituted by a case 16, and a partition plate 17 provided in the case 16, and is structured such that only an output port of the tray 1 is open. In this case, an openable lid in the output port is omitted. Five trays 1a to 1e and five trays 1f to 1j are laminated and stored per respective shelves surrounded by the case 16 and the partition plate 17. In this case, it goes without saying that a number of the partition plates 17 and a number of the trays laminated in the shelf can be changed.

As mentioned above, in accordance with the present invention, since the tray can be stored in the laminated state, there is obtained an effect that it is possible to increase a storing number of the optical discs per the cartridge. Further, since the partition plate is provided in the cartridge, it is possible to reduce a load applied to the tray from the other trays, so that there is obtained an effect that it is possible to reduce a force scuffing the tray and a driving force at a time of taking out and storing the tray.

A description will be given of a structure of an embodiment of an optical disc recording and reproducing apparatus 21 shown in FIG. 5. The optical disc recording and reproducing apparatus 21 is constituted by a casing 22, a cartridge insertion port 23 provided in the casing 22, the tray 1 storing the optical disc 10, the cartridge 15 storing a lot of trays 1 in a laminated manner, a cartridge moving table 24 fixing the cartridge 15 and moving the cartridge 15 in a vertical direction, a horizontal moving mechanism 35 for pulling out the tray 10 from the cartridge 15 or storing the tray 10 in the cartridge 15, a hook mechanism 36 provided in the horizontal moving mechanism 35 for hooking the tray 10, a driving portion 37 for moving the horizontal moving mechanism 35 in a horizontal direction, the peeling claw 26 for peeling the cover of the tray 1, a tray detection sensory 27 for positioning the tray 10 in the hook mechanism 36, a fixed base 38 provided with the horizontal moving mechanism 35, the driving portion 37 and the tray detection sensor 27 and set for mounting the taken-out tray 10, a spindle motor 29 for fixing and rotating the optical disc 10 and the glass disc 31 to the clamp portion 30, a recording and reproducing portion 32 recording and reproducing the data of the optical disc 10, a driving portion 33 for moving the recording and reproducing portion 32 in a horizontal direction, an oscillation mechanism 42 for peeling the optical disc 10 from the glass disc 31, a recording and reproducing portion moving table 34 mounting the spindle motor 29, the recording and reproducing portion 32 and the oscillation mechanism 42 thereon so as to move in a vertical direction, a cap 39 fixing the optical disc 10 to the clamp portion 30, a cap holder 41 guiding the cap 39 in such a manner as to be movable up and down and right and left, a clamp portion moving table 40 mounting the cap holder 41 thereon and moving in a vertical direction, a support member 25 fixed to the casing 22 and supporting the movement in the vertical direction of the cartridge moving table 24, and a support member 28 fixed to the casing 22 and supporting the movement in the vertical direction of the recording and reproducing portion moving table 34 and the clamp portion moving table 40. In this case, the cartridge moving table 24, the recording and reproducing portion moving table 34 and the clamp portion moving table 40 are applied a driving force by a moving mechanism (not shown) so as to move. Further, an interval between the optical disc 10 and the recording and reproducing portion 32 is preferably between about 0.65 mm and 3.5 mm. Further, a thickness of the glass disc is preferably between about 0.5 mm and 0.6 mm.

Next, a description will be given of a load operation of pulling out the tray 1 from the cartridge 15 so as to set the optical disc 10 to the clamp portion 30. First, the target tray 1 is positioned at a horizontal level of the hook mechanism 36 by detecting a position of the tray 1 by the tray detection sensor 27 while moving the cartridge moving table 24. Next, the horizontal moving mechanism 35 is moved and the hook mechanism 36 is inserted to the gap of the laminated trays 1 of the cartridge 15 so as to be hooked to the hook hole of the tray 1. Next, the horizontal moving mechanism 35 is moved, and the tray 1 is pulled out of the cartridge 15 so as to be positioned at a predetermined position in the fixed base 38. After the pulling operation, the cover 4 of the tray 1 is brought into contact with the peeling claw 26 so as to be peeled off upward. Further, as shown in FIG. 5, all of the optical discs 10 are taken out of the cartridge 15, however, a part of the trays 1 are left in the cartridge 15. Next, the recording and reproducing portion moving table 35 is moved downward and the clamp portion 30 is inserted to the clamp hole 11 of the optical disc 10. Next, the clamp portion moving table 40 is moved upward, and the cap 39 is adsorbed to the clamp portion 30 on the basis of a magnetic force of the clamp portion 30 so as to fix the optical disc 10. In this state, the cap 39 comes to a state in which the cap 39 is not in contact with the cap holder 41. Next, the recording and reproducing portion moving table 34 and the clamp portion moving table 40 are moved upward, and the optical disc 10 is moved to a predetermined position where the optical disc 10 is not in contact with the tray 1. This is executed for rotating the optical disc 10 after moving to the position at which the hanging optical disc 10 due to its own weight is not in contact with the tray 1. Next, the spindle motor 29 is started, and the optical disc 10 is rotated. The optical disc 10 is pressed against the glass disc 31 on the basis of an air flow, and is rotated in a state having no surface deflection. Next, the recording and reproducing of the optical disc 10 is executed by the recording and reproducing portion 32. In this case, the surface deflection reduction of the optical disc 10 can be further effectively achieved by setting a hole in an inner peripheral side of the glass disc 31 so as to flow the air flow into a portion between the glass disc 31 and the optical disc 10. Further, since the structure of fixing the optical disc 10 to the lower side of the glass disc 31 is made in such a manner that a light beam of the recording and reproducing portion is focused on the optical disc 10, an area of a light spot is larger at a position in an upper side of the glass disc 31 even in the case that a dust is attached to the upper side of the glass disc 31, so that there is obtained an effect that a reduction of a light intensity is small and it is possible to reduce an error in recording and reproducing.

Next, a description will be given of an unload operation of storing the optical disc 10 in the cartridge 15 from the recording and reproducing state. First, after stopping the spindle motor 29 from the recording and reproducing state, the optical disc 10 is peeled off from the glass disc 31 by hitting or oscillating the glass disc 31 by the oscillation mechanism 42. Next, the optical disc 10 is brought into contact with the tray 1 by moving the recording and reproducing portion moving table 34 and the clap portion moving table 40 downward. Next, the cap 39 is separated from the clamp portion 30 so as to be moved to a standby state by moving the clamp portion moving table 40 downward. Accordingly, the optical disc 10 is transferred to the tray 1. Next, the recording and reproducing portion moving table 34 is moved upward so as to be moved in a standby state. Next, the horizontal moving mechanism 35 is moved, and the tray 1 is moved so as to be pushed by the hook mechanism 36 and is stored in the cartridge 15. In accordance that the tray 1 is inserted to the cartridge 15, the cover 4 is turned back to the tray 1 so as to cover the optical disc 10. Next, the horizontal moving mechanism 35 is turned back to the standby state.

As mentioned above, in accordance with the present invention, there is obtained an effect that it is possible to take out the optical disc 10 which is stored in the tray 1 so as to be laminated from the cartridge 15 without damaging in a random order, record and reproduce the data at a high precision in a state of no surface oscillation of the optical disc, and thereafter accurately turn back the optical disc 10 at a high speed to the original position of the cartridge 15 without damaging.

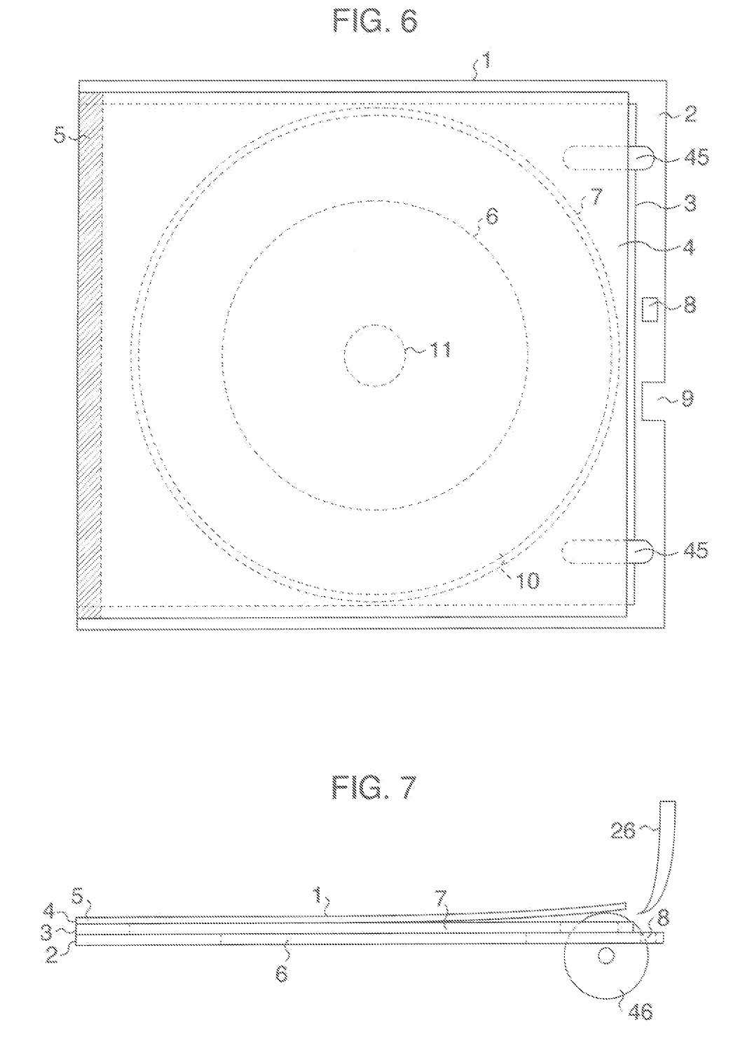

Next, the other embodiment of the tray 1 is shown in FIGS. 6 and 7. In FIG. 6, the same constituting elements as those of the tray 1 in FIG. 1 will be indicated by the same reference numerals. FIG. 7 shows a view obtained by viewing FIG. 6 from the side. A structure of FIG. 6 corresponds to a structure in which the tray 1 in FIG. 1 is provided with a hole 45 passing through the flat plate 2 and the flat plate 3. As shown in FIG. 7, if the tray 1 is moved onto the roller 46, the roller 46 jumps out of the hole 45 provided in the tray 1 so as to hold up the cover 4. Accordingly, it is possible to insert the peeling claw 26 to a lower side of the cover 4.

As mentioned above, in accordance with the present invention, since a gap can be provided between the cover 4 and the flat plate 2, there can be obtained an effect that it is possible to easily insert the peeling claw 26 of the peeling mechanism for holding up the cover 4.

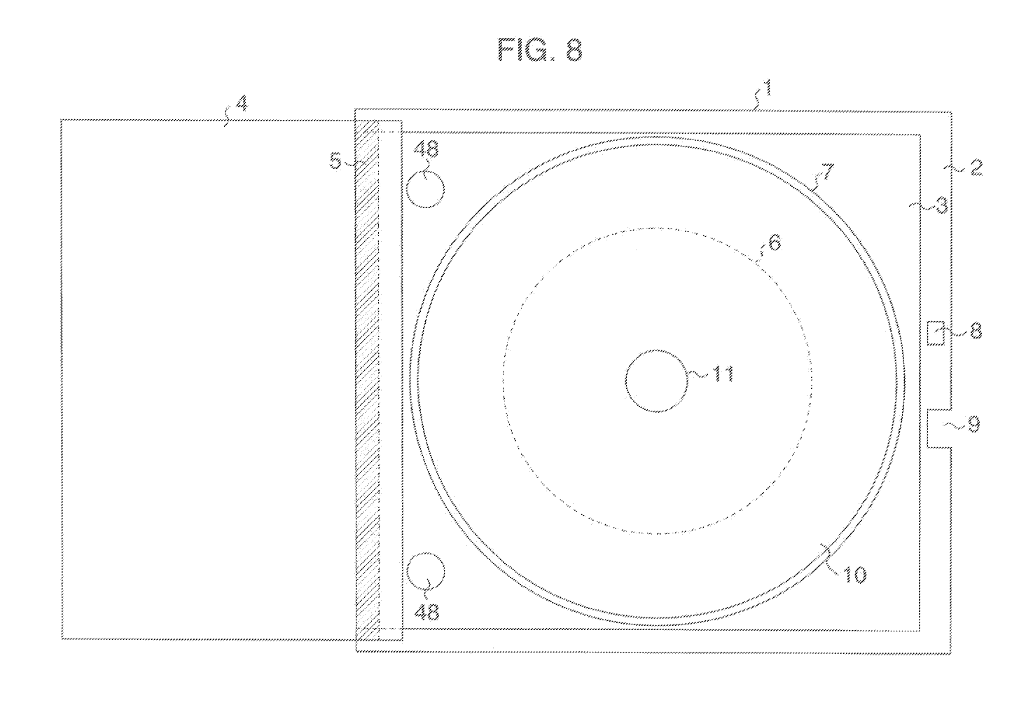

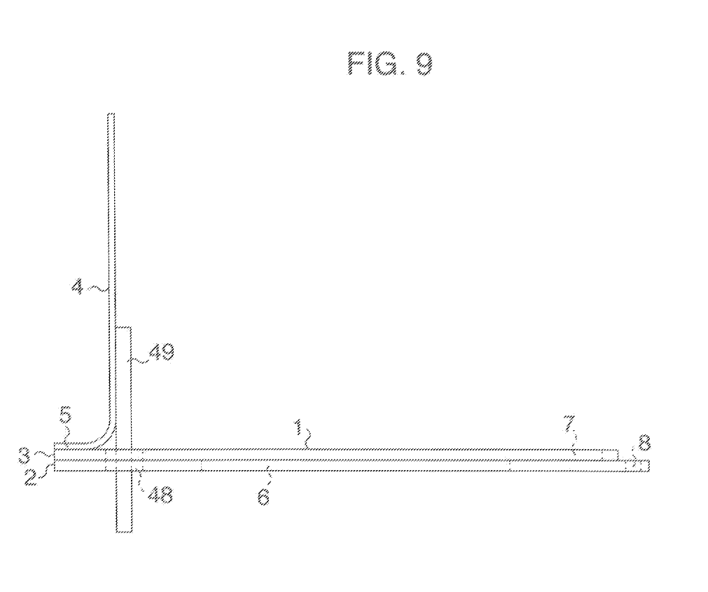

Next, the other embodiment of the tray 1 is shown in FIGS. 8 and 9. In FIG. 8, the same constituting elements as those of the tray 1 in FIG. 1 will be indicated by the same reference numerals. FIG. 9 shows a view obtained by viewing FIG. 8 from the side. A structure of FIG. 8 corresponds to a structure in which the tray 1 in FIG. 1 is provided with a hole 48 passing through the flat plate 2 and the flat plate 3. As shown in FIG. 9, it is possible to hold up the cover 4 by inserting a peeling rod 49 to the hole 48 of the tray 1.

As mentioned above, in accordance with the present invention, there is obtained an effect that the cover 4 can be held up by the simple mechanism.

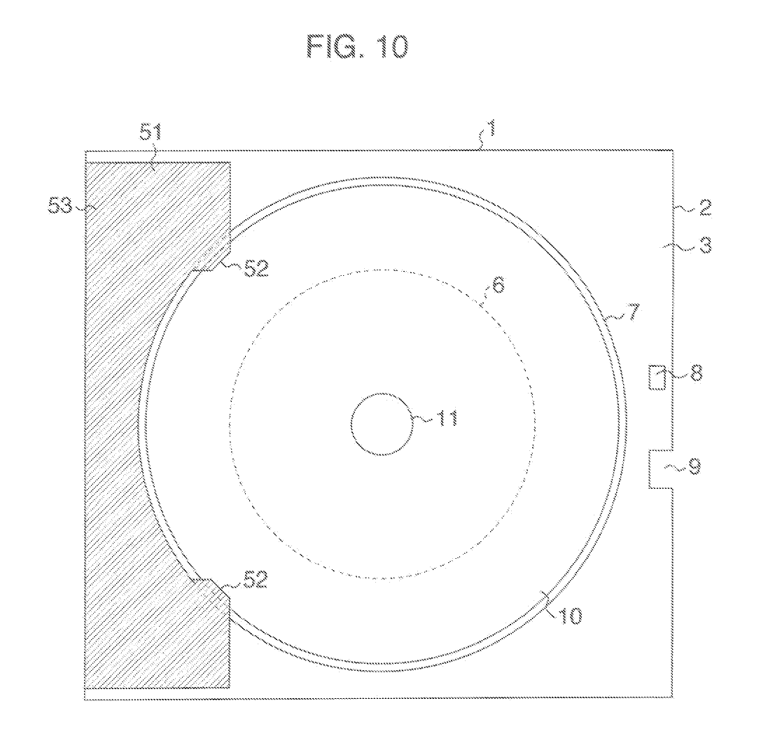

Next, the other embodiment of the tray 1 is shown in FIG. 10. In FIG. 10, the same constituting elements as those of the tray 1 in FIG. 1 will be indicated by the same reference numerals. A structure of FIG. 10 is provided with a cover 51 in place of the tray 1 in FIG. 1. The cover 51 is provided with a projection portion 52 protruding to a concave portion side in which the optical disc 10 is accommodated. The cover 51 is adhered to the flat plate 3 by a diagonal line portion 53. In this case, in the case of taking out the optical disc 10 from the tray 1 and turning back the optical disc 10 to the tray 1, the projection portion 52 and the optical disc 10 are deformed, so that it is possible to take out and store.

As mentioned above, in accordance with the present invention, there is obtained an effect that it is possible to hold the optical disc 10 by the projection portion 52 of the cover 51 in such a manner as to prevent the optical disc from dropping from the tray 1. Further, there is obtained an effect that it is possible to take out the optical disc 10 from the tray 1 and turn back the optical disc 10 to the tray 1.

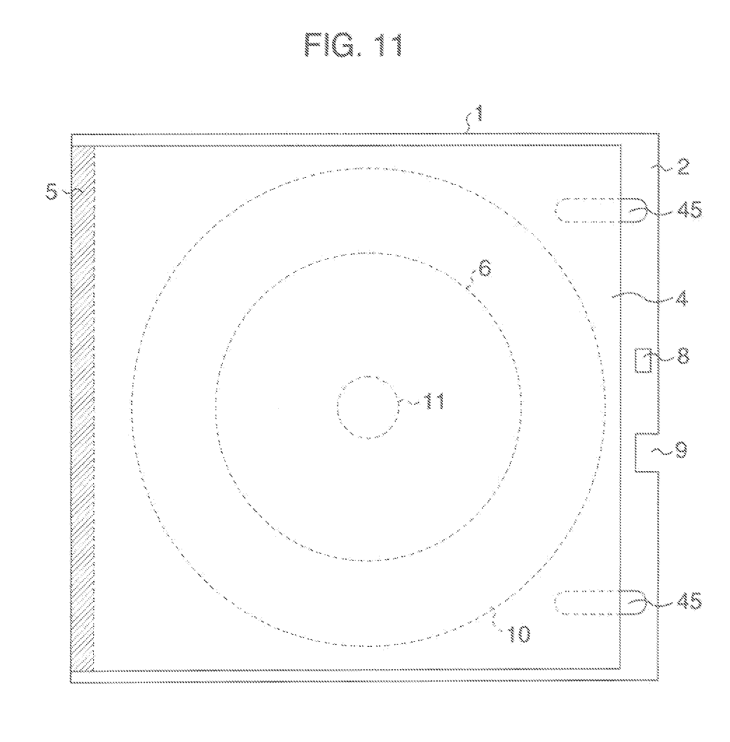

Next, the other embodiment of the tray 1 is shown in FIG. 11. In FIG. 11, the same constituting elements as those of the tray 1 in FIG. 6 will be indicated by the same reference numerals. A structure of FIG. 11 corresponds to a structure in which the flat plate 3 of the tray 1 in FIG. 6 is omitted. Further, the cover 4 may be integrally structured by bending the flat plate 2 by the adhesive portion 5.

As mentioned above, in accordance with the present invention, there is obtained an effect that the optical disc 10 can be held to the tray 1 on the basis of the simple structure.

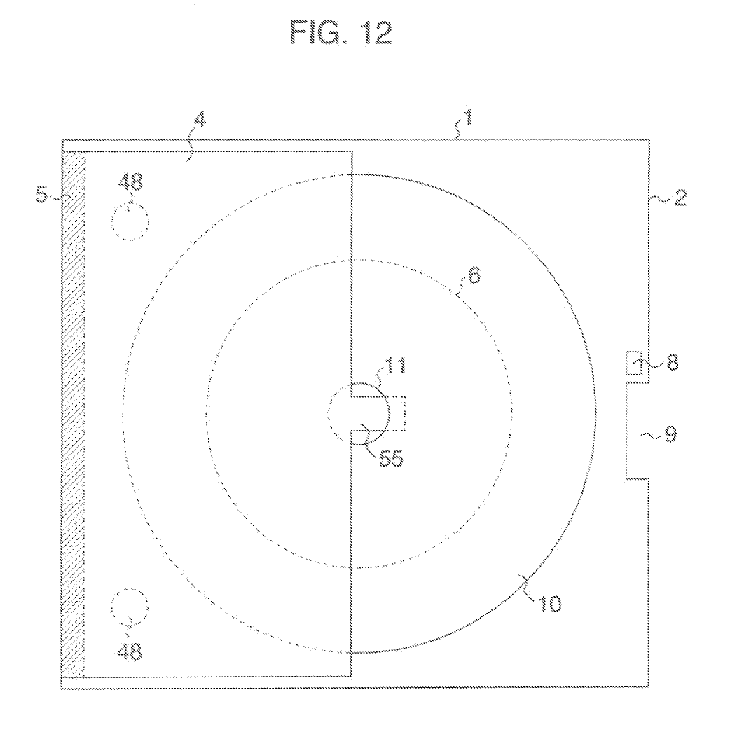

Next, the other embodiment of the tray 1 is shown in FIG. 12. In FIG. 12, the same constituting elements as those of the tray 1 in FIG. 8 will be indicated by the same reference numerals. A structure of FIG. 12 corresponds to a structure in which the flat plate 3 of the tray 1 in FIG. 8 is omitted. Further, the cover 4 is provided with an insertion portion 55 which can be inserted to the clamp hole 11 of the optical disc 10. In this case, the cover 4 may be integrally structured by bending the flat plate 2 by the adhesive portion 5.

As mentioned above, in accordance with the present invention, since the insertion portion 55 of the cover 4 is inserted to the clamp hole 11 of the optical disc 10, there is obtained an effect that it is possible to hold the optical disc 10 without protruding from the tray 1.

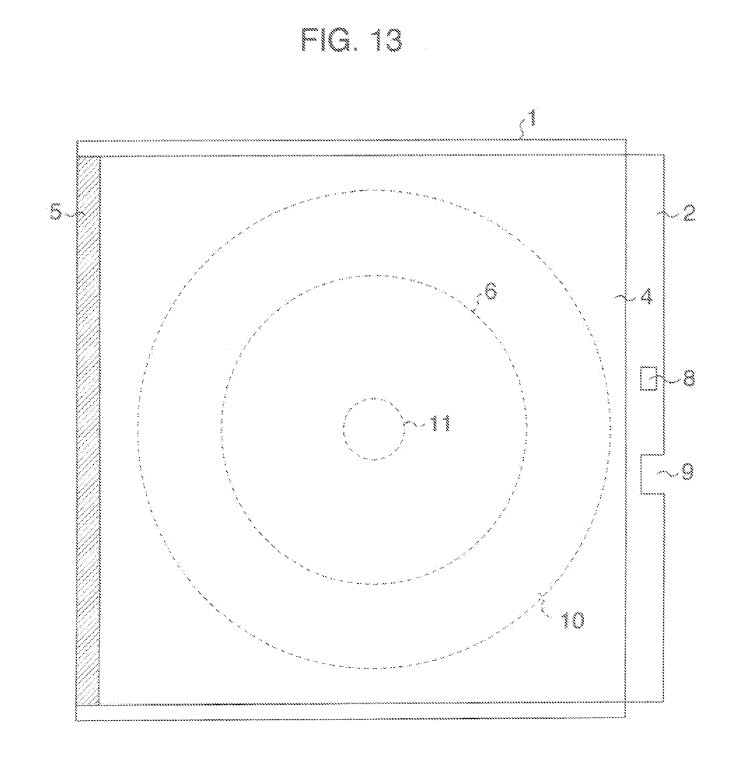

Next, the other embodiment of the tray 1 is shown in FIG. 13. In FIG. 13, the same constituting elements as those of the tray 1 in FIG. 1 will be indicated by the same reference numerals. A structure of FIG. 13 corresponds to a structure in which the flat plate 3 of the tray 1 in FIG. 1 is omitted. Further, a magnitude of the cover 4 is longer than the flat plate 2 in a width direction, and is set to a length which does not cover the hook hole 8 and the notch portion 9 in a length direction. Further, the cover 4 may be integrally structured by bending the flat plate 2 by the adhesive portion 5.

As mentioned above, in accordance with the present invention, there is obtained an effect that it is possible to hold the optical disc 10 to the tray 1 on the basis of the simple structure. Further, since a gap can be provided below the cover 4, there is obtained an effect that it is possible to easily insert the peeling mechanism (the peeling claw 26 in FIG. 5) for holding up the cover 4.

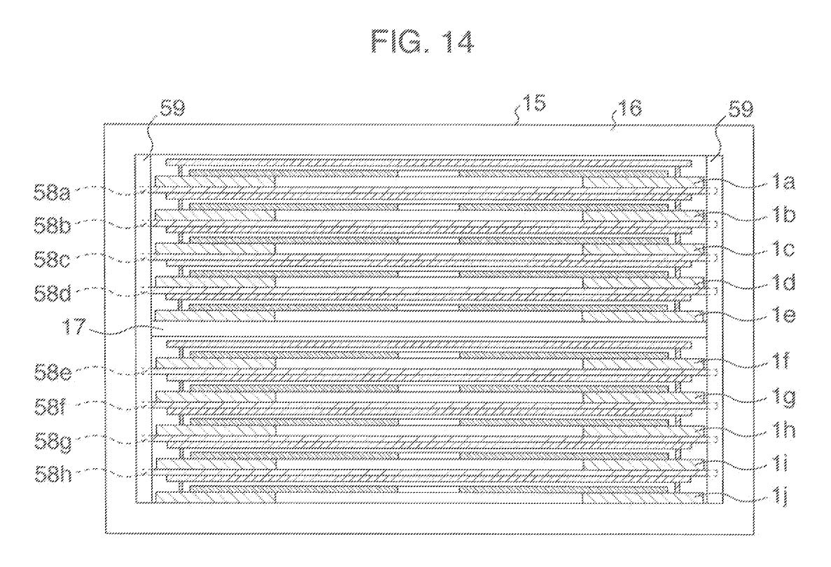

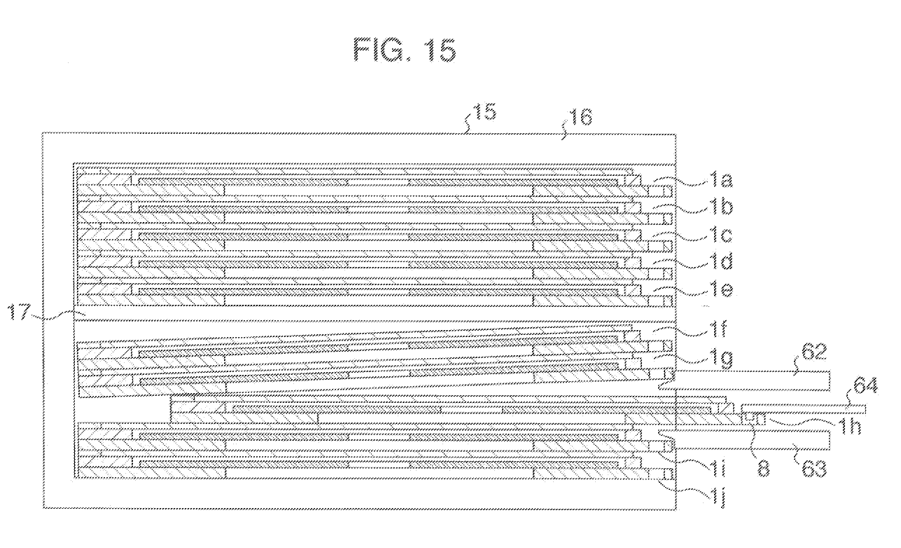

Next, the other embodiment of the cartridge 15 is shown in FIG. 14. In FIG. 14, the same constituting elements as those of the cartridge 15 in FIG. 4 will be indicated by the same reference numerals. A structure of FIG. 14 corresponds to a structure in which flat separators 58a to 58h having a width direction longer than the tray are inserted to a portion between the adjacent trays in the laminated trays 1a to 1j. In this case, the separators 58a to 58h are not fixed. Further, a stop plate 59 is provided in the case 16 in such a manner as to prevent the separators 58a to 58h from moving in the take-out direction of the tray. In this case, the separator 58 and the stop plate 59 may employ the other structures as far as the separator 58 can move in the vertical direction and can not move in the take-out direction of the tray. Further, it goes without saying that the number of the partition plates 17 and the number of the trays laminated in the shelf can be changed.

As mentioned above, in accordance with the present invention, since the separator is provided between the adjacent trays, there is obtained an effect that the adjacent upper and lower trays are not taken out together at a time of taking out the tray. Since the trays can be stored while being laminated, there is obtained an effect that the adjacent upper and lower trays are not taken out together at a time of taking out the tray. Since the trays are stored while being laminated, there is obtained an effect that the storing number of the optical discs per the cartridge can be increased. Further, since the partition plate is provided in the cartridge, there is obtained an effect that it is possible to reduce the load applied to the tray from the other trays and it is possible to reduce the force scuffing the tray and the driving force at a time of taking out and storing the tray.

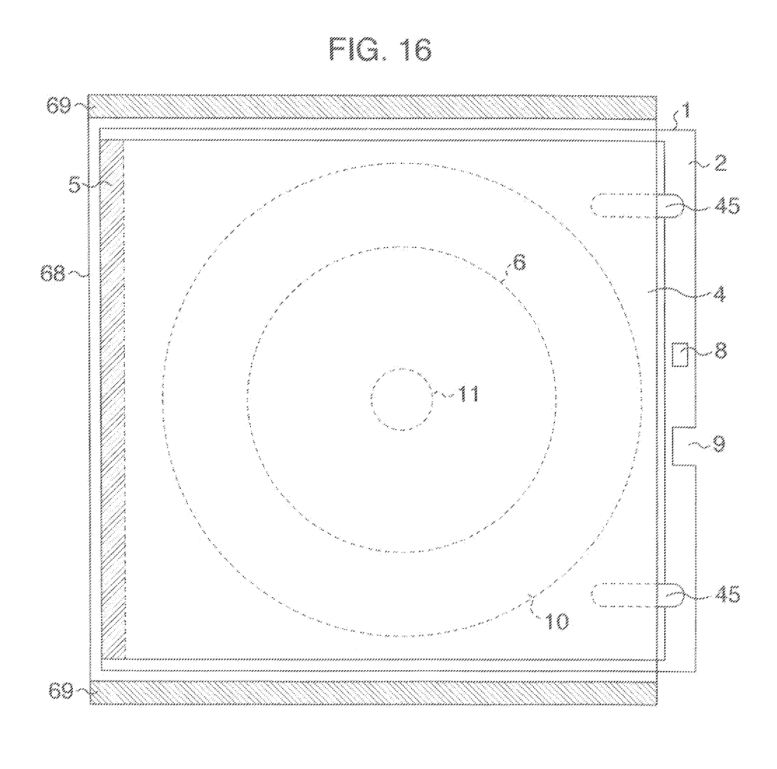

Next, FIG. 15 shows the other embodiment of the mechanism of taking out the tray 1 from the cartridge 15. FIG. 15 is a view of the cartridge 15 and the tray 1 in FIG. 4 as seen from the side, and the same constituting elements as those of the cartridge 15 in FIG. 4 will be indicated by the same reference numerals. A structure of FIG. 15 is made such that a leading end of the tray 1g is suspended in an upward direction by a block plate 62 in such a manner as to prevent the adjacent upper and lower trays 1g and 1i to the taken-out tray 1h from being taken out together. Further, the tray 1i is pressed in a downward direction by a block plate 63.

As mentioned above, in accordance with the present invention, there is obtained an effect that the adjacent upper and lower trays are not taken out together at a time of taking out the tray. Further, since the tray is suspended, there is obtained an effect that it is possible to reduce the load applied to the tray from the other trays and it is possible to reduce the force scuffing the tray and the driving force at a time of taking out and storing the tray.

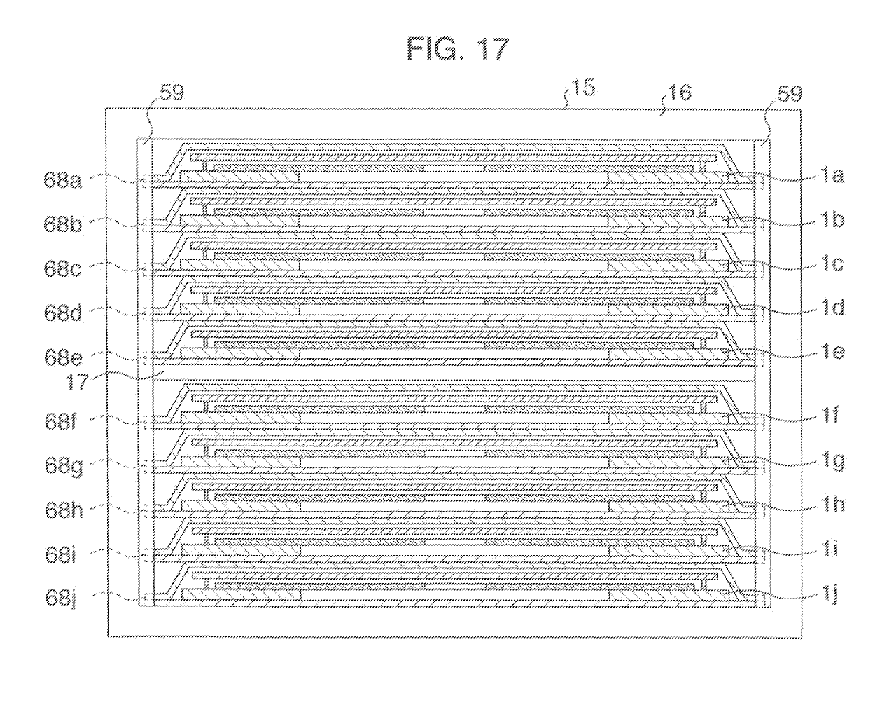

Next, the other embodiment of the cartridge 15 is shown in FIGS. 16 and 17. FIG. 16 shows a structure in which the tray 1 shown in FIG. 11 is stored in a tray case 68. In FIG. 16, the same constituting elements as those of the tray 1 in FIG. 11 will be indicated by the same reference numerals. The tray case 68 is formed in a bag shape in which one sheet is folded and adhered by an adhesive portion 69 shown by a diagonal line portion.

FIG. 17 shows a cartridge 15 in which tray cases 68a to 68j storing the trays 1a to 1j in FIG. 16 are laminated. In FIG. 17, the same constituting elements as those of the cartridge 15 in FIG. 14 will be indicated by the same reference numerals. A stop plate 59 is provided in the case 16 in such a manner as to prevent the tray cases 68a to 68j from moving in the take-out direction of the tray. In this case, the tray case 68 and the stop plate 59 can employ the other structures as far as the tray case 68 can move in the vertical direction and can not move in the take-out direction of the tray. Further, it goes without saying that the number of the partition plates 17 and the number of the tray cases laminated in the shelf can be changed.

As mentioned above, in accordance with the present invention, since the tray is put in the tray case, there is obtained an effect that the adjacent upper and lower trays are not taken out together, at a time of taking out the tray. Since the tray can be stored while being laminated, there is obtained an effect that it is possible to increase the storing number of the optical discs per the cartridge. Further, since the partition plate is provided in the cartridge, there is obtained an effect that it is possible to reduce the load applied to the tray from the other trays, and it is possible to reduce the force scuffing the tray and the driving force at a time of taking out and storing the tray.

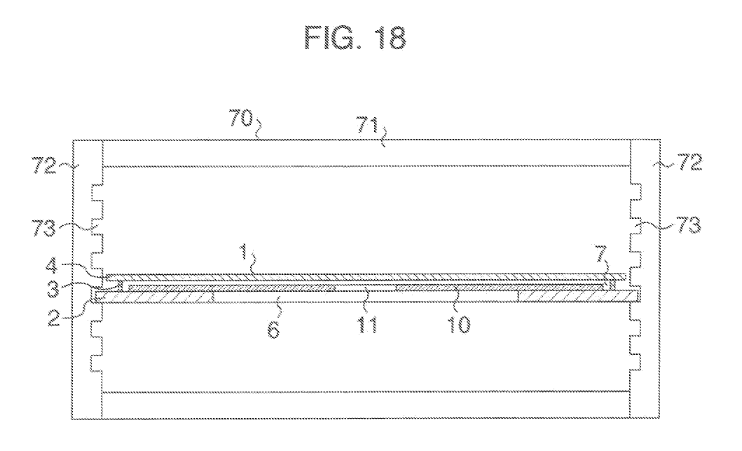

Next, FIG. 18 shows the other embodiment of the cartridge. A cartridge 70 in FIG. 18 is constituted by a case 71, a side plate 72 of the case 71, and grooves 73 provided in the side plate 72. An interval of the grooves 73 is set equal to or more than a thickness of the tray 1. A lot of trays 1 are inserted to the groove 73 and stored in the cartridge 70.

As mentioned above, in accordance with the present invention, since the gap is provided between the adjacent trays, there is obtained an effect that the upper and lower trays are not taken out together at a time of taking out the tray. Since it is possible to store the thin tray, there is obtained an effect that it is possible to increase the storing number of the optical discs per the cartridge. Further, since the load of the other trays is not applied to the tray, there is obtained an effect that it is possible to reduce the force scuffing the tray and the driving fore at a time of taking out and storing the tray.

As mentioned above, in accordance with the present embodiment, the description is given of the sheet-shaped optical disc, however, the present invention can be applied to a sheet-shaped magnetic disc. Further, it is possible to structure a high-capacity image recording apparatus which can record a monitor camera image, a TV program and the like for a long time, by combining the optical disc recording and reproducing apparatus in accordance with the present invention, the magnetic disc apparatus and a semiconductor memory.

1. A cartridge storing a lot of trays each accommodating an optical disc, wherein said tray is provided with a cover covering said optical disc.

2. A cartridge storing a lot of trays each accommodating an optical disc, wherein the cartridge stores the tray accommodating said optical disc, an outer peripheral portion of said tray is provided with a hook hole for taking out said tray, and said hook hole is provided in each of said trays in such a manner that said hook holes of said trays are adjacent at a time of storing said tray in the cartridge.

3. A cartridge as claimed in claim 1, wherein shelves are provided in said cartridge, and said trays are stored while being separated per a plurality of trays.

4. A cartridge as claimed in claim 1, wherein a sheet-shaped separator is inserted to a portion between said trays accommodating said optical discs.

5. A recording and reproducing apparatus comprising:
a cartridge storing a tray accommodating an optical disc and provided with a cover covering said optical disc; and
a means for taking out said tray from said cartridge and taking out said optical disc from said tray so as to record and reproduce,
wherein said tray has a protruding portion formed by protruding one side of said cover, and said optical disc is recorded and reproduced by peeling said cover after holding up said protruding portion at a time of taking out the tray, and taking out said optical disc.

6. A recording and reproducing apparatus comprising:
a cartridge storing a tray accommodating an optical disc and provided with a cover covering said optical disc; and
a means for taking out said tray from said cartridge and taking out said optical disc from said tray so as to record and reproduce,
wherein said tray has a hole inserting a member for holding up said cover, and said optical disc is recorded and reproduced by peeling said cover after inserting said member to said hole for holding up said cover and holding up said cover at a time of taking out the tray, and taking out said optical disc.

7. A recording and reproducing apparatus comprising:
a cartridge storing a lot of trays each accommodating an optical disc; and
a means for taking out said tray from said cartridge and taking out said optical disc from said tray so as to record and reproduce,
wherein a part of said tray is left in said cartridge at time of taking out said tray.
